(19) United States
(12) Patent Application Publication
(10) Pub. No.: US 2024/0308916 A1
(43) Pub. Date: Sep. 19, 2024

(54) MICROWAVE FERRITE MATERIAL FOR THIRD-ORDER INTERMODULATION CIRCULATOR AND PREPARATION METHOD THEREFOR

(71) Applicant: HENGDIAN GROUP DMEGC MAGNETICS CO., LTD, Dongyang City Jinhua, Zhejiang (CN)

(72) Inventors: Feiyu LV, Dongyang City Jinhua, Zhejiang (CN); Yuanzhen WANG, Dongyang City Jinhua, Zhejiang (CN); Likang ZHANG, Dongyang City Jinhua, Zhejiang (CN)

(21) Appl. No.: 18/575,267

(22) PCT Filed: Aug. 4, 2022
(86) PCT No.: PCT/CN2022/110191

§ 371 Date: Dec. 28, 2023

(30) Foreign Application Priority Data
Nov. 2, 2021 (CN) 202111291814.1

(51) Int. Cl. C04B 35/26; C04B 35/626; C04B 35/634; C04B 35/64; H01F 1/34; H01P 1/38

(52) U.S. Cl. CPC C04B 35/2641; C04B 35/6262; C04B 35/6264; C04B 35/62655; C04B 35/62675; C04B 35/6268; C04B 35/62695; C04B 35/63416; C04B 35/64; H01F 1/344; C04B 2235/3225; C04B 2235/3274; C04B 2235/3293; C04B 2235/3294; C04B 2235/3418; C04B 2235/442; C04B 2235/5436; C04B 2235/5445; C04B 2235/604; C04B 2235/606; C04B 2235/6562; C04B 2235/6565; C04B 2235/6567; C04B 2235/6585; H01P 1/38

(57) ABSTRACT

A microwave ferrite material for a third-order intermodulation circulator and a preparation method therefor, the chemical formula being Y₃₋ₐCaₐSnₐIn_{b}Mn_{c}Fe_{5-a-b-c}O₁₂, 0.1≤a≤0.3, 0.01≤b≤0.1, 0.001≤c≤0.1. The preparation method comprises the following steps: (1) weighing; (2) first ball milling; (3) drying and preheating; (4) second ball milling; (5) granulation; and (6) post-treatment. The microwave ferrite material reduces the intermodulation interference between combined signals, and further improves the performance of communication systems and the coverage and capacity of networks. At the same time, it is ensured that the stability and repeatability of the preparation process are maintained at a good level, being suitable for mass production applications.

### TECHNICAL FIELD

Examples of the present application relate to the technical field of magnetic materials, for example, a microwave ferrite material, and especially relate to a microwave ferrite material for a third-order intermodulation circulator and a preparation method therefor.

### BACKGROUND

In the deployment of communication networks, it is quite common for different operators to share base station network systems to save costs. Due to the different communication technologies adopted by operators as well as the nonlinear factors in the systems, there are interferences arising from the combined signals. Intermodulation interference is one of the typical interference phenomena, which leads to the deterioration of the performance of the communication system and seriously affects the network coverage and capacity. There are many factors that affect the intermodulation interference; in addition to improving the indices of active and passive equipment based on the original case, reasonable frequency planning is also required according to different scenes and in conjunction with standardized network coverage construction process. With the development of communication technology, there are increasingly higher performance requirements on the microwave ferrite materials from the market, in particular, more stringent requirements on the third-order intermodulation.

CN110128129A discloses a preparation method for a low-loss garnet ferrite material, comprising the following steps: (1) proportioning raw materials; (2) primary ball milling; (3) pre-sintering; (4) secondary ball milling; (5) granulation; (6) compress molding; and (7) sintering. In the method, the granulation uses a nano-modified binder prepared from nano TiO₂, nano SiO₂ and polyvinyl alcohol, and before the granulation, the materials after the secondary ball milling and the nano-modified binder are mixed uniformly under vacuum pressurized conditions. By the preparation method, the prepared garnet ferrite material is able to have few lattice defects, low porosity, and regular, uniform and dense microstructure, and the loss of the material is effectively reduced.

CN102584200A discloses an ultra-low loss, small linewidth microwave ferrite material and a preparation method therefor; the microwave ferrite material has a chemical formula of Y_{3-2x-y}Ca_{2x-y}Fe_{5-x-y-z}VₓZr_{y}Al₂O₁₂, wherein 0.02≤x≤0.25, 0.05≤y≤0.25, and 0.01≤ z≤0.25; the preparation method comprises the following steps: weighing out raw materials according to calculation based on the stoichiometry, vibratory ball milling, pre-sintering, coarse pulverization by vibratory milling, fine pulverization by sand milling, spray granulation, compress molding and sintering. After testing, the obtained material has a ferromagnetic resonance linewidth ΔH of less than or equal to 1.27 KA/m, and a dielectric loss tgδe of less than or equal to 0.5×10⁻⁴, and the assembled microwave device has an insertion loss of less than or equal to 0.21 dB; the stability and reliability of the obtained material is greatly improved, and the application range is expanded; the assembled microwave ferrite device has the advantages of broad operating frequency band and low insertion loss.

CN104496450A discloses a narrow-linewidth low-loss gyromagnetic ferrite material and a preparation method therefor; the gyromagnetic ferrite material has a chemical formula of Y₃₋ₓCaₓFe_{5-x-3y}Li_{y}Sn_{2y+x}O₁₂, wherein 0.01≤x≤0.3, and 0.001≤y≤0.04; the preparation method is as follows: weighing out raw materials according to calculation based on the chemical formula, mixing, pre-sintering, pulverization by sand milling, centrifugal spray granulation, compress molding, sintering, grinding, annealing and coating silver. After testing, the obtained material has a saturation magnetization intensity Ms of 123.4 kA/m-159.2 kA/m, a gyromagnetic resonance linewidth ΔH of less than or equal to 1.2 kA/m, and a dielectric loss tgδe of less than or equal to 0.5×10⁻⁴, and the assembled 25.7×31.5×10 circulator has an insertion loss of less than or equal to 0.16 dB when tested at 925 MHz-960 MHz. The sintering temperature of the material is low, which is energy-efficient and environmentally friendly; the grain has a diameter of 7-18 μm, and is uniform and complete with few defects.

However, the third-order intermodulation parameters of the ferrite materials obtained in the above applications need to be further improved; therefore, at present, it is an urgent problem to be solved by those skilled in the art about how to provide a microwave ferrite material for third-order intermodulation circulators and a preparation method therefor, so as to reduce the intermodulation interference among combined signals, and further enhance the performance of communication systems as well as the coverage and capacity of network, and meanwhile maintain the stability and repeatability of preparation process at a satisfied level to suit mass production.

### SUMMARY

The following is a summary of the subject matter described in detail herein. This summary is not intended to limit the protection scope of the claims.

An embodiment of the present application provides a microwave ferrite material for a third-order intermodulation circulator and a preparation method therefor; the microwave ferrite material reduces the intermodulation interference among combined signals, and further enhances the performance of communication systems as well as the coverage and capacity of network, and meanwhile, the preparation process is guaranteed to maintain the stability and repeatability at a satisfied level, which is suitable for mass production.

In a first aspect, an example of the present application provides a microwave ferrite material for a third-order intermodulation circulator, and the microwave ferrite material has a chemical formula of Y₃₋ₐCaₐSnₐIn_{b}Mn_{c}Fe_{5-a-b-c}O₁₂, wherein 0.1≤a≤0.3, 0.01≤b≤0.1, and 0.001≤c≤0.1.

In the present application, 0.1<a≤0.3, for example, a may be 0.1, 0.12, 0.14, 0.16, 0.18, 0.2, 0.22, 0.24, 0.26, 0.28 or 0.3, but is not limited to the listed values, and other unlisted values within the numerical range are also applicable.

In the present application, 0.01≤b≤0.1, for example, b may be 0.01, 0.02, 0.03, 0.04, 0.05, 0.06, 0.07, 0.08, 0.09 or 0.1, but is not limited to the listed values, and other unlisted values within the numerical range are also applicable.

In the present application, 0.001≤c≤0.1, for example, c may be 0.001, 0.005, 0.01, 0.02, 0.03, 0.04, 0.05, 0.06, 0.07, 0.08, 0.09 or 0.1, but is not limited to the listed values, and other unlisted values within the numerical range are also applicable.

The microwave ferrite material provided by the present application, on the basis of the original 4G communication low-loss garnet microwave ferrite material, employs Ca element to partly replace the rare earth element Y, and employs Sn, Mn, and In elements to partly replace the Fe element, which obtains the appropriate 4πMs, ΔH, and Tc with the electromagnetic properties and compensation points of the elements, and in particular, the combined replacement by Sn and Mn gives the ferrite material appropriate 4πMs and Curie temperature.

Preferably, raw materials of the microwave ferrite material comprise Y₂O₃, CaCO₃, SnO₂, In₂O₃, MnCO₃ and Fe₂O₃.

Preferably, the Y₂O₃ has a purity of more than or equal to 99.95%, which may be, for example, 99.95%, 99.96%, 99.97%, 99.98% or 99.99%, but is not limited to the listed values, and other unlisted values within the numerical range are also applicable.

Preferably, the CaCO₃ has a purity of more than or equal to 99.5%, which may be, for example, 99.5%, 99.6%, 99.7%, 99.8% or 99.9%, but is not limited to the listed values, and other unlisted values within the numerical range are also applicable.

Preferably, the SnO₂ has a purity of more than or equal to 99.5%, which may be, for example, 99.5%, 99.6%, 99.7%, 99.8% or 99.9%, but is not limited to the listed values, and other unlisted values within the numerical range are also applicable.

Preferably, the In₂O₃ has a purity of more than or equal to 99.99%, which may be, for example, 99.99%, 99.992%, 99.994%, 99.996% or 99.998%, but is not limited to the listed values, and other unlisted values within the numerical range are also applicable.

Preferably, the MnCO₃ has a purity of more than or equal to 99%, which may be, for example, 99%, 99.2%, 99.4%, 99.6% or 99.8%, but is not limited to the listed values, and other unlisted values within the numerical range are also applicable.

Preferably, the Fe₂O₃ has a purity of more than or equal to 99.5%, which may be, for example, 99.5%, 99.6%, 99.7%, 99.8% or 99.9%, but is not limited to the listed values, and other unlisted values within the numerical range are also applicable.

In a second aspect, an embodiment of the present application provides a preparation method for the microwave ferrite material according to the first aspect, and the preparation method comprises the following steps:
a. weighing: weighing out corresponding raw materials according to calculation based on the composition of the microwave ferrite material;
b. primary ball milling: mixing deionized water, zirconia balls, a dispersant and the raw materials weighed out in step (1), and performing ball milling to obtain a first slurry;
c. drying and pre-heating: drying and pre-sintering the first slurry obtained in step (2) sequentially to obtain a first powder;
d. secondary ball milling: mixing deionized water, zirconia balls, a co-solvent and the first powder obtained in step (3), and performing ball milling to obtain a second slurry;
e. granulation: mixing a binder and the second slurry obtained in step (4), and performing centrifugal spray to obtain a second powder; and
f. after-treatment: molding, sintering and grinding the second powder obtained in step (5) sequentially to obtain the microwave ferrite material.

For the preparation method provided by the present application, by optimizing the powder-preparation process and using the reasonable iron-deficient formulation, the linewidth of material and the loss of device are reduced, and by optimizing the sintering process while guaranteeing the optimal formulation, the best image of the crystal of material is obtained, thereby improving the product's third-order intermodulation parameters, and additionally, the preparation process is stable and repeatable, which is suitable for mass production.

Preferably, the mixing in step (2) has a mass ratio of raw materials: deionized water: zirconia balls=1: (1-1.3): (4-8), which may be, for example, 1:1:4, 1:1.1:5, 1:1.2:6, 1:1.2:7 or 1:1.3:8, but is not limited to the listed values, and other unlisted values within the numerical range are also applicable.

Preferably, the dispersant in step (2) comprises acetone.

Preferably, the dispersant in step (2) has a mass proportion of 1-10% in the first slurry, which may be, for example, 1%, 2%, 3%, 4%, 5%, 6%, 7%, 8%, 9% or 10%, but is not limited to the listed values, and other unlisted values within the numerical range are also applicable.

Preferably, the ball milling in step (2) has a rotation speed of 60-80 rpm, which may be, for example, 60 rpm, 62 rpm, 64 rpm, 66 rpm, 68 rpm, 70 rpm, 72 rpm, 74 rpm, 76 rpm, 78 rpm or 80 rpm, but is not limited to the listed values, and other unlisted values within the numerical range are also applicable.

Preferably, the ball milling in step (2) is carried out for a period of 20-40 h, which may be, for example, 20 h, 22 h, 24 h, 26 h, 28 h, 30 h, 32 h, 34 h, 36 h, 38 h or 40 h, but is not limited to the listed values, and other unlisted values within the numerical range are also applicable.

Preferably, the first slurry in step (2) has a particle size X50 of 0.5-1.0 μm, which may be, for example, 0.5 μm, 0.6 μm, 0.7 μm, 0.8 μm, 0.9 μm or 1.0 μm, but is not limited to the listed values, and other unlisted values within the numerical range are also applicable.

In the present application, the particle size X50 denotes the particle size value corresponding to a cumulative distribution percentage of 50%.

Preferably, the drying in step (3) has a temperature of 120-150° C., which may be, for example, 120° C., 125° C., 130° C., 135° C., 140° C., 145° C. or 150° C., but is not limited to the listed values, and other unlisted values within the numerical range are also applicable.

Preferably, the drying in step (3) is carried out for a period of 16-20 h, which may be, for example, 16 h, 16.5 h, 17 h, 17.5 h, 18 h, 18.5 h, 19 h, 19.5 h or 20 h, but is not limited to the listed values, and other unlisted values within the numerical range are also applicable.

Preferably, step (3) further comprises screening a powder between the drying and the pre-heating.

Preferably, the screening is performed with a mesh size of 40-80 mesh, which may be, for example, 40 mesh, 45 mesh, 50 mesh, 55 mesh, 60 mesh, 65 mesh, 70 mesh, 75 mesh or 80 mesh, but is not limited to the listed values, and other unlisted values within the numerical range are also applicable.

Preferably, the pre-heating in step (3) has a temperature of 1200-1300° C., which may be, for example, 1200° C., 1210° C., 1220° C., 1230° C., 1240° C., 1250° C., 1260° C., 1270° C., 1280° C., 1290° C. or 1300° C., but is not limited to the listed values, and other unlisted values within the numerical range are also applicable.

Preferably, the pre-heating in step (3) has a heating rate of 1-2° C./min, which may be, for example, 1° C./min, 1.1° C./min, 1.2° C./min, 1.3° C./min, 1.4° C./min, 1.5° C./min, 1.6° C./min, 1.7° C./min, 1.8° C./min, 1.9° C./min or 2° C./min, but is not limited to the listed values, and other unlisted values within the numerical range are also applicable.

Preferably, the pre-heating in step (3) is carried out for a period of 4-8 h, which may be, for example, 4 h, 4.5 h, 5 h, 5.5 h, 6 h, 6.5 h, 7 h, 7.5 h or 8 h, but is not limited to the listed values, and other unlisted values within the numerical range are also applicable.

Preferably, the pre-heating in step (3) is performed in an oxygen atmosphere, and oxygen introduction begins when the temperature increases to 800° C., and ends when the temperature decreases to 800° C., and the oxygen introduction has a flow rate of 20-50 L/min, which may be, for example, 20 L/min, 25 L/min, 30 L/min, 35 L/min, 40 L/min, 45 L/min or 50 L/min, but is not limited to the listed values, and other unlisted values within the numerical range are also applicable.

Preferably, the mixing in step (4) has a mass ratio of first powder: deionized water: zirconia balls=1: (1-1.3): (4-8), which may be, for example, 1:1:4, 1:1.1:5, 1:1.2:6, 1:1.2:7 or 1:1.3:8, but is not limited to the listed values, and other unlisted values within the numerical range are also applicable.

Preferably, the co-solvent in step (4) comprises SiO₂.

In the present application, the co-solvent SiO₂ is able to increase the degree of the solid-phase reaction of the material and reduce the porosity.

Preferably, the co-solvent in step (4) has a concentration of 50-500 ppm in the second slurry, which may be, for example, 50 ppm, 100 ppm, 150 ppm, 200 ppm, 250 ppm, 300 ppm, 350 ppm, 400 ppm, 450 ppm or 500 ppm, but is not limited to the listed values, and other unlisted values within the numerical range are also applicable.

Preferably, the ball milling in step (4) has a rotation speed of 50-80 rpm, which may be, for example, 50 rpm, 55 rpm, 60 rpm, 65 rpm, 70 rpm, 75 rpm or 80 rpm, but is not limited to the listed values, and other unlisted values within the numerical range are also applicable.

Preferably, the ball milling in step (4) is carried out for a period of 30-50 h, which may be, for example, 30 h, 32 h, 34 h, 36 h, 38 h, 40 h, 42 h, 44 h, 46 h, 48 h or 50 h, but is not limited to the listed values, and other unlisted values within the numerical range are also applicable.

Preferably, the second slurry in step (4) has a particle size X50 of 0.4-0.9 μm, which may be, for example, 0.4 μm, 0.5 μm, 0.6 μm, 0.7 μm, 0.8 μm or 0.9 μm, but is not limited to the listed values, and other unlisted values within the numerical range are also applicable.

Preferably, the binder in step (5) comprises an aqueous solution of polyvinyl alcohol.

Preferably, the binder in step (5) has a concentration of 9-11 wt %, which may be, for example, 9 wt %, 9.2 wt %, 9.4 wt %, 9.6 wt %, 9.8 wt %, 10 wt %, 10.2 wt %, 10.4 wt %, 10.6 wt %, 10.8 wt % or 11 wt %, but is not limited to the listed values, and other unlisted values within the numerical range are also applicable.

Preferably, the binder in step (5) has an addition amount of 8-12 wt %, which may be, for example, 8 wt %, 8.5 wt %, 9 wt %, 9.5 wt %, 10 wt %, 10.5 wt %, 11 wt %, 11.5 wt % or 12 wt %, but is not limited to the listed values, and other unlisted values within the numerical range are also applicable.

Preferably, the second powder in step (5) has a particle size X85 of 60-80 μm, which may be, for example, 60 μm, 62 μm, 64 μm, 66 μm, 68 μm, 70 μm, 72 μm, 74 μm, 76 μm, 78 μm or 80 μm, but is not limited to the listed values, and other unlisted values within the numerical range are also applicable.

In the present application, the particle size X85 denotes the particle size value corresponding to a cumulative distribution percentage of 85%.

Preferably, the molding in step (6) is performed with a 100T press.

Preferably, the molding in step (6) yields a cylinder with a density of 3-3.5 g/cm³, which may be, for example, 3 g/cm³, 3.1 g/cm³, 3.2 g/cm³, 3.3 g/cm³, 3.4 g/cm³ or 3.5 g/cm³, but is not limited to the listed values, and other unlisted values within the numerical range are also applicable.

Preferably, a heating stage of the sintering in step (6) comprises three steps, specifically, a first sintering, a second sintering and a third sintering which are performed sequentially.

Preferably, the first sintering has a temperature of 550-650° C., which may be, for example, 550° C., 560° C., 570° C., 580° C., 590° C., 600° C., 610° C., 620° C., 630° C., 640° C. or 650° C., but is not limited to the listed values, and other unlisted values within the numerical range are also applicable.

Preferably, the first sintering has a heating rate of 0.5-1.5° C./min, which may be, for example, 0.5° C./min, 0.6° C./min, 0.7° C./min, 0.8° C./min, 0.9° C./min, 1° C./min, 1.1° C./min, 1.2° C./min, 1.3° C./min, 1.4° C./min or 1.5° C./min, but is not limited to the listed values, and other unlisted values within the numerical range are also applicable.

Preferably, the second sintering has a temperature of 950-1050° C., which may be, for example, 950° C., 960° C., 970° C., 980° C., 990° C., 1000° C., 1010° C., 1020° C., 1030° C., 1040° C. or 1050° C., but is not limited to the listed values, and other unlisted values within the numerical range are also applicable.

Preferably, the second sintering has a heating rate of 1.5-2.5° C./min, which may be, for example, 1.5° C./min, 1.6° C./min, 1.7° C./min, 1.8° C./min, 1.9° C./min, 2° C./min, 2.1° C./min, 2.2° C./min, 2.3° C./min, 2.4° C./min or 2.5° C./min, but is not limited to the listed values, and other unlisted values within the numerical range are also applicable.

Preferably, the third sintering has a temperature of 1400-1500° C., which may be, for example, 1400° C., 1410° C., 1420° C., 1430° C., 1440° C., 1450° C., 1460° C., 1470° C., 1480° C., 1490° C. or 1500° C., but is not limited to the listed values, and other unlisted values within the numerical range are also applicable.

Preferably, the third sintering has a heating rate of 2-3° C./min, which may be, for example, 2° C./min, 2.1° C./min, 2.2° C./min, 2.3° C./min, 2.4° C./min, 2.5° C./min, 2.6° C./min, 2.7° C./min, 2.8° C./min, 2.9° C./min or 3° C./min, but is not limited to the listed values, and other unlisted values within the numerical range are also applicable.

Preferably, the third sintering has a holding time of 20-40 h, which may be, for example, 20 h, 22 h, 24 h, 26 h, 28 h, 30 h, 32 h, 34 h, 36 h, 38 h or 40 h, but is not limited to the listed values, and other unlisted values within the numerical range are also applicable.

Preferably, a cooling stage of the sintering in step (6) comprises two steps, and specifically, the sintered product is firstly cooled to 600° C. at a rate of 1-2° C./min and then cooled naturally, and the rate may be, for example, 1° C./min, 1.1° C./min, 1.2° C./min, 1.3° C./min, 1.4° C./min, 1.5° C./min, 1.6° C./min, 1.7° C./min, 1.8° C./min, 1.9° C./min or 2° C./min, but is not limited to the listed values, and other unlisted values within the numerical range are also applicable.

Preferably, the sintering in step (6) is performed in an oxygen atmosphere, and oxygen introduction begins when the temperature increases to 900° C., and ends when the temperature decreases to 700° C., and the oxygen introduction has a flow rate of 30-50 L/min, which may be, for example, 30 L/min, 32 L/min, 34 L/min, 36 L/min, 38 L/min, 40 L/min, 42 L/min, 44 L/min, 46 L/min, 48 L/min or 50 L/min, but is not limited to the listed values, and other unlisted values within the numerical range are also applicable.

Preferably, the grinding in step (6) is performed with a centerless grinder.

As a preferred technical solution in the second aspect of the present application, the preparation method comprises the following steps:
a. weighing: weighing out corresponding raw materials according to calculation based on the composition of the microwave ferrite material;
b. primary ball milling: adding the raw materials weighed out in step (1) into a ball milling jar for mixing with a ball mill, feeding materials according to a mass ratio of raw materials: deionized water: zirconia balls=1: (1-1.3): (4-8), adding acetone as a dispersant, and performing ball milling, wherein the ball milling is carried out for a period of 20-40 h with a rotation speed of 60-80 rpm, to obtain a first slurry; the dispersant has a mass proportion of 1-10% in the first slurry, and the first slurry has a particle size X50 of 0.5-1.0 μm;
c. drying and pre-heating: drying the first slurry obtained in step (2) with an oven, wherein the drying is carried out at a temperature of 120-150° C. for 16-20 h; screening the dried powder with a sieve of 40-80 mesh, and pre-sintering the screened powder with an air sintering furnace, wherein the screened powder is heated to 1200-1300° C. at a rate of 1-2° C./min and held for 4-8 h, to obtain a first powder; the pre-heating is performed in an oxygen atmosphere, and oxygen introduction begins when the temperature increases to 800° C., and ends when the temperature decreases to 800° C., and the oxygen introduction has a flow rate of 20-50 L/min;
d. secondary ball milling: adding the first powder obtained in step (3) into a ball milling jar for mixing with a ball mill, feeding materials according to a mass ratio of first powder: deionized water: zirconia balls=1: (1-1.3): (4-8), adding SiO₂ as a co-solvent, and performing ball milling, wherein the ball milling is carried out for a period of 30-50 h with a rotation speed of 50-80 rpm, to obtain a second slurry; the co-solvent has a concentration of 50-500 ppm in the second slurry, and the second slurry has a particle size X50 of 0.4-0.9 μm;
e. granulation: adding an aqueous solution of polyvinyl alcohol as a binder at a concentration of 9-11 wt % to the second slurry obtained in step (4), wherein the binder has an addition amount of 8-12 wt %, and performing centrifugal spray to obtain a second powder which has a particle size X85 of 60-80 μm; and
f. after-treatment: molding, sintering and grinding the second powder obtained in step (5) sequentially to obtain the microwave ferrite material; the molding is performed with a 100T press and yields a cylinder with a density of 3-3.5 g/cm³; a heating stage of the sintering comprises three steps, specifically, a first sintering, a second sintering and a third sintering which are performed sequentially; the first sintering has a temperature of 550-650° C. and a heating rate of 0.5-1.5° C./min; the second sintering has a temperature of 950-1050° C. and a heating rate of 1.5-2.5° C./min; the third sintering has a temperature of 1400-1500° C., a heating rate of 2-3° C./min, and a holding time of 20-40 h; a cooling stage of the sintering comprises two steps, and specifically, the sintered product is firstly cooled to 600° C. at a rate of 1-2° C./min and then cooled naturally; the sintering is performed in an oxygen atmosphere, and oxygen introduction begins when the temperature increases to 900° C., and ends when the temperature decreases to 700° C., and the oxygen introduction has a flow rate of 30-50 L/min; the grinding is performed with a centerless grinder.

In a third aspect, an embodiment of the present application provides use of the microwave ferrite material according to the first aspect in manufacturing a third-order intermodulation circulator.

Compared with the related art, the embodiments of the present application have the following beneficial effects:
a. the microwave ferrite material provided by the embodiments of the present application, on the basis of the original 4G communication low-loss garnet microwave ferrite material, employs Ca element to partly replace the rare earth element Y, and employs Sn, Mn, and In elements to partly replace the Fe element, which obtains the appropriate saturation magnetization intensity, ferromagnetic resonance linewidth, and Curie temperature with the electromagnetic properties and compensation points of the elements, and in particular, the combined replacement by Sn and Mn gives the ferrite material appropriate saturation magnetization intensity (ΔH<15 oe) and Curie temperature (Tc>250° C.); and
b. for the preparation method provided by the embodiments of the present application, by optimizing the powder-preparation process and using the reasonable iron-deficient formulation, the linewidth of material and the loss of device are reduced, and by optimizing the sintering process while guaranteeing the optimal formulation, the best image of the crystal of material is obtained, thereby improving the product's third-order intermodulation parameters (25° C. IMD>75 dB, 125° C. IMD>70 dB), and additionally, the preparation process is stable and repeatable, which is suitable for mass production.

Other aspects can become apparent upon reading and understanding the accompanying drawings and detailed description.

### BRIEF DESCRIPTION OF DRAWINGS

The accompanying drawings are used to provide further understanding of the technical solutions herein, constitute part of the specification, and explain the technical solutions herein in conjunction with examples of the present application, but do not constitute a limitation on the technical solutions herein.

FIG. 1 is a sintered-crystal image of a microwave ferrite material obtained in Example 1;

FIG. 2 is a sintered-crystal image of a microwave ferrite material obtained in Example 3;

FIG. 3 is a sintered-crystal image of a microwave ferrite material obtained in Example 4.

### DETAILED DESCRIPTION

The technical solutions of the present application are further described below through specific embodiments. It should be clear to those skilled in the art that the examples are merely used for a better understanding of the present application and should not be regarded as a specific limitation on the present application.

### Example 1

This example provides a microwave ferrite material for third-order a intermodulation circulator and a preparation method therefor, and the preparation method comprises the following steps:
a. weighing: raw materials were weighed out correspondingly based on the chemical formula of the microwave ferrite material, i.e., Y₃₋ₐCaₐSnₐIn_{b}Mn_{c}Fe_{5-a-b-c}O₁₂ (a=0.27, b=0.01, c=0.05), wherein Y₂O₃ had a purity of more than or equal to 99.95%; CaCO₃ had a purity of more than or equal to 99.5%; SnO₂ had a purity of more than or equal to 99.5%; In₂O₃ had a purity of more than or equal to 99.99%; MnCO₃ had a purity of more than or equal to 99%; and Fe₂O₃ had a purity of more than or equal to 99.5%;
b. primary ball milling: the raw materials weighed out in step (1) were added into a ball milling jar for mixing with a ball mill, and materials were fed according to a mass ratio of raw materials: deionized water: zirconia balls=1:1:6, added with acetone as a dispersant, and subjected to ball milling, wherein the ball milling was carried out for a period of 35 h with a rotation speed of 60 rpm, to obtain a first slurry; the dispersant had a mass proportion of 5% in the first slurry, and the first slurry had a particle size X50 of 0.75 μm;
c. drying and pre-heating: the first slurry obtained in step (2) was dried with an oven, wherein the drying was carried out at a temperature of 150° C. for 16 h; the dried powder was screened with a 60-mesh sieve, and pre-sintered with an air sintering furnace, wherein the screened powder was heated to 1280° C. at a rate of 1.5° C./min and held for 8 h, to obtain a first powder; the pre-heating was performed in an oxygen atmosphere, and oxygen introduction began when the temperature increased to 800° C., and ended when the temperature decreased to 800° C., and the oxygen introduction had a flow rate of 30 L/min;
d. secondary ball milling: the first powder obtained in step (3) was added into a ball milling jar for mixing with a ball mill, and materials were fed according to a mass ratio of first powder: deionized water: zirconia balls=1:1:6, added with SiO₂ as a co-solvent, and subjected to ball milling, wherein the ball milling is carried out for a period of 36 h with a rotation speed of 60 rpm, to obtain a second slurry; the co-solvent had a concentration of 200 ppm in the second slurry, and the second slurry had a particle size X50 of 0.61 μm;
e. granulation: the second slurry obtained in step (4) was added with an aqueous solution of polyvinyl alcohol as a binder at a concentration of 9 wt %, wherein the binder had an addition amount of 9 wt %, and subjected to centrifugal spray to obtain a second powder which had a particle size X85 of 70 μm; and
f. after-treatment: the second powder obtained in step (5) was molded, sintered and ground sequentially to obtain the microwave ferrite material; the molding was performed with a 100T press and yielded a cylinder with a density of 3.2 g/cm³; a heating stage of the sintering included three steps, specifically, a first sintering, a second sintering and a third sintering which were performed sequentially; the first sintering had a temperature of 600° C. and a heating rate of 1° C./min; the second sintering had a temperature of 1000° C. and a heating rate of 2° C./min; the third sintering had a temperature of 1480° C., a heating rate of 2.5° C./min, and a holding time of 24 h; a cooling stage of the sintering included two steps, and specifically, the sintered product was firstly cooled to 600° C. at a rate of 1.5° C./min and then cooled naturally; the sintering was performed in an oxygen atmosphere, and oxygen introduction began when the temperature increased to 900° C., and ended when the temperature decreased to 700° C., and the oxygen introduction has a flow rate of 40 L/min; the grinding was performed with a centerless grinder.

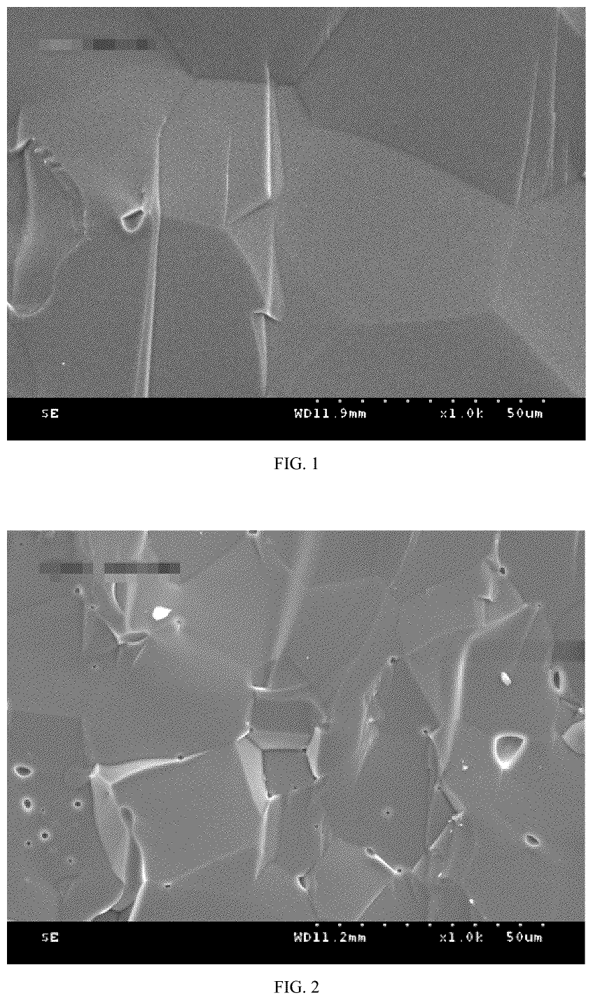

The sintered-crystal image of the microwave ferrite material obtained in this example is shown in FIG. 1.

### Example 2

This example provides a microwave ferrite material for a third-order intermodulation circulator and a preparation method therefor, except that the chemical formula of the microwave ferrite material was Y₃₋ₐCaₐSnₐIn_{b}Mn_{c}Fe_{5-a-b-c}O₁₂ (a=0.26, b=0.01, c=0.02), and for the preparation method, the concentration of the co-solvent in step (4) was changed to 100 ppm in the second slurry, the other conditions were the same as those in Example 1, which will not be described in detail herein.

### Example 3

This example provides a microwave ferrite material for a third-order intermodulation circulator and a preparation method therefor, except that the temperature of the third sintering in step (6) was changed to 1510° C. for the preparation method, the other conditions were the same as those in Example 1, which will not be described in detail herein.

The sintered-crystal image of the microwave ferrite material obtained in this example is shown in FIG. 2.

As can be seen from FIG. 2, compared with Example 1, the temperature of the third sintering is too high in this example, resulting in more defects on the crystal surface of the obtained microwave ferrite material.

### Example 4

This example provides a microwave ferrite material for a third-order intermodulation circulator and a preparation method therefor, except that the temperature of the third sintering in step (6) was changed to 1390° C. for the preparation method, the other conditions were the same as those in Example 1, which will not be described in detail herein.

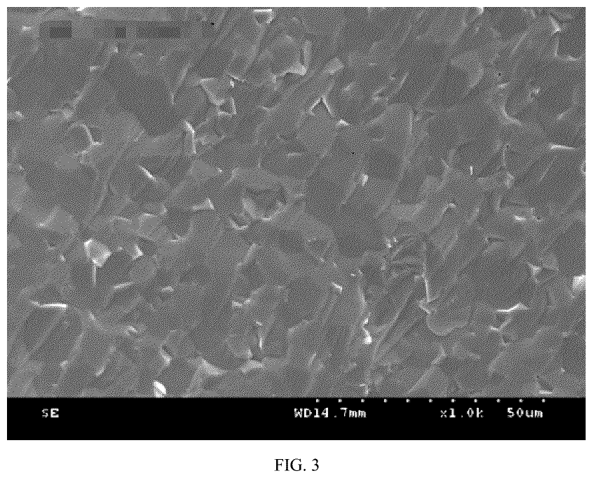

The sintered-crystal image of the microwave ferrite material obtained in this example is shown in FIG. 3.

As can be seen from FIG. 3, compared with Example 1, the temperature of the third sintering is too low in this example, resulting in decreased crystal maturity of the obtained microwave ferrite material.

### Example 5

This example provides a microwave ferrite material for a third-order intermodulation circulator and a preparation method therefor, except that no co-solvent of SiO₂ was added in step (4) for the preparation method, the other conditions were the same as those in Example 1, which will not be described in detail herein.

### Example 6

This example provides a microwave ferrite material for a third-order intermodulation circulator and a preparation method therefor, except that no oxygen introduction was performed in step (6) for the preparation method, the other conditions were the same as those in Example 1, which will not be described in detail herein.

### Comparative Example 1

This comparative example provides a microwave ferrite material for a third-order intermodulation circulator and a preparation method therefor, except that the chemical formula of the microwave ferrite material was Y₃₋ₐCaₐSnₐIn_{b}Mn_{c}Fe_{5-a-b-c}O₁₂ (a=0.32, b=0.01, c=0.05), the other conditions and the preparation method were the same as in Example 1, which will not be described in detail herein.

### Comparative Example 2

This comparative example provides a microwave ferrite material for a third-order intermodulation circulator and a preparation method therefor, except that the chemical formula of the microwave ferrite material was Y₃₋ₐCaₐSnₐIn_{b}Mn_{c}Fe_{5-a-b-c}O₁₂ (a=0.27, b=0.01, c=0.15), the other conditions and the preparation method were the same as in Example 1, which will not be described in detail herein.

The microwave ferrite materials obtained in Examples 1-6 and Comparative Examples 1-2 were subjected to the following performance tests:
a. the density ρ of the sample was tested by using the Archimedes' drainage method;
b. the dielectric constant ε was tested by machining the sample into a thin rod of Φ1.6 mm×22 mm;
c. the ferromagnetic resonance linewidth ΔH was tested by polishing the sample into a sphere of Φ1 mm;
d. the saturation magnetization intensity 4πMs and Curie temperature Tc were tested by machining the sample into a sphere of Φ2.5 mm; and
e. the third-order intermodulation parameters IMD at 25° C. and 125° C. were tested separately by machining the sample into a specification of H20.5×17×1.0.

The specific results of the above performance tests are shown in Table 1.

TABLE 1

| | | | | | | Third-order | Third-order |
|---|---|---|---|---|---|---|---|
| | Saturation | | Ferromagnetic | | | intermodulation | intermodulation |
| | magnetization | Curie | resonance | | | parameter | parameter |
| | intensity | temperature | linewidth | Dielectric | Density | at 25° C. | at 125° C. |
| | 4πMs | Tc | ΔH | constant | ρ | IMD | IMD |
| No. | (Gs) | (° C.) | (oe) | ∈ | (g/cm³) | (dB) | (dB) |
| Standard | 1950 ± 50 | >250 | <15 | 14.5 ± 2 | >5.0 | >75 | >70 |
| Example 1 | 1953 | 253 | 12 | 14.52 | 5.12 | 79 | 72 |
| Example 2 | 1931 | 255 | 13 | 14.49 | 5.11 | 78 | 73 |
| Example 3 | 1905 | 253 | 28 | 14.47 | 5.00 | 80 | 76 |
| Example 4 | 1896 | 253 | 35 | 14.47 | 4.86 | 68 | 63 |
| Example 5 | 1906 | 256 | 30 | 14.47 | 4.92 | 72 | 68 |
| Example 6 | 1945 | 253 | 30 | 14.32 | 5.02 | 75 | 69 |
| Comparative | 1885 | 245 | 15 | 14.15 | 5.06 | 73 | 68 |
| Example 1 | | | | | | | |
| Comparative | 1920 | 250 | 25 | 14.38 | 5.06 | 77 | 72 |
| Example 2 | | | | | | | |

As can be seen from Table 1: each of the performance parameters in Examples 1-2 is up to standard; due to the overly high temperature of the third sintering in Example 3, the ferromagnetic resonance linewidth is too broad; due to the overly low temperature of the third sintering in Example 4, the ferromagnetic resonance linewidth is too broad, and the saturation magnetization intensity and third-order intermodulation parameters all decrease; due to the absence of co-solvent SiO₂ in Example 5, the solid-phase reaction of the material has a lower degree, increasing the porosity, and the ferromagnetic resonance linewidth is too broad, and the third-order intermodulation parameters decrease; because oxygen is not introduced to the sintering process in Example 6, the ferromagnetic resonance linewidth is too broad, and the third-order intermodulation parameters decrease; the excessive Ca element in Comparative Example 1 results in overly low saturation magnetization intensity and Curie temperature as well as inferior third-order intermodulation parameters than Example 1; and the excessive Mn element in Comparative Example 2 results in overly broad ferromagnetic resonance linewidth.

It can be seen that the microwave ferrite material provided by the present application, on the basis of the original 4G communication low-loss garnet microwave ferrite material, employs Ca element to partly replace the rare earth element Y, and employs Sn, Mn, and In elements to partly replace the Fe element, which obtains the appropriate saturation magnetization intensity, ferromagnetic resonance linewidth, and Curie temperature with the electromagnetic properties and compensation points of the elements, and in particular, the combined replacement by Sn and Mn gives the ferrite material appropriate saturation magnetization intensity (ΔH<15 oe) and Curie temperature (Tc>250° C.); moreover, for the preparation method provided by the present application, by optimizing the powder-preparation process and using the reasonable iron-deficient formulation, the linewidth of material and the loss of device are reduced, and by optimizing the sintering process while guaranteeing the optimal formulation, the best image of the crystal of material is obtained, thereby improving the product's third-order intermodulation parameters (25° C. IMD>75 dB, 125° C. IMD>70 dB), and additionally, the preparation process is stable and repeatable, which is suitable for mass production.

The applicant declares that the above is only specific embodiments of the present application, but the protection scope of the present application is not limited thereto, and it should be apparent to those skilled in the art that any changes or substitutions, which are obvious under the technical teaching disclosed by the present application, shall all fall within the protection and disclosure scope of the present application.

What is claimed is:

1. A microwave ferrite material for a third-order intermodulation circulator, wherein the microwave ferrite material has a chemical formula of Y₃₋ₐCaₐSnₐIn_{b}Mn_{c}Fe_{5-a-b-c}O₁₂, wherein 0.1≤a≤0.3, 0.01<b≤0.1, and 0.001≤c≤0.1.

2. The microwave ferrite material according to claim 1, wherein raw materials of the microwave ferrite material comprise Y₂O₃, CaCO₃, SnO₂, In₂O₃, MnCO₃ and Fe₂O₃.

3. The microwave ferrite material according to claim 2, wherein the Y₂O₃ has a purity of more than or equal to 99.95%;
preferably, the CaCO₃ has a purity of more than or equal to 99.5%;
preferably, the SnO₂ has a purity of more than or equal to 99.5%;
preferably, the In₂O₃ has a purity of more than or equal to 99.99%;
preferably, the MnCO₃ has a purity of more than or equal to 99%;
preferably, the Fe₂O₃ has a purity of more than or equal to 99.5%.

4. preparation method for the microwave ferrite material according to claim 1, comprising the following steps:
(1) weighing: weighing out corresponding raw materials according to calculation based on the composition of the microwave ferrite material;
(2) primary ball milling: mixing deionized water, zirconia balls, a dispersant and the raw materials weighed out in step (1), and performing ball milling to obtain a first slurry;
(3) drying and pre-heating: drying and pre-sintering the first slurry obtained in step (2) sequentially to obtain a first powder;
(4) secondary ball milling: mixing deionized water, zirconia balls, a co-solvent and the first powder obtained in step (3), and performing ball milling to obtain a second slurry;
(5) granulation: mixing a binder and the second slurry obtained in step (4), and performing centrifugal spray to obtain a second powder; and
(6) after-treatment: molding, sintering and grinding the second powder obtained in step (5) sequentially to obtain the microwave ferrite material.

5. The preparation method according to claim 4, wherein the mixing in step (2) has a mass ratio of raw materials: deionized water: zirconia balls=1: (1-1.3):(4-8).

6. The preparation method according to claim 4, wherein the dispersant in step (2) comprises acetone.

7. The preparation method according to claim 4, wherein the dispersant in step (2) has a mass proportion of 1-10% in the first slurry.

8. The preparation method according to claim 4, wherein the ball milling in step (2) has a rotation speed of 60-80 rpm;
preferably, the ball milling in step (2) is carried out for a period of 20-40 h.

9. The preparation method according to claim 4, wherein the drying in step (3) has a temperature of 120-150° C.;
preferably, the drying in step (3) is carried out for a period of 16-20 h;
preferably, step (3) further comprises screening a powder between the drying and the pre-heating;
preferably, the screening is performed with a mesh size of 40-80 mesh;
preferably, the pre-heating in step (3) has a temperature of 1200-1300° C.;
preferably, the pre-heating in step (3) has a heating rate of 1-2° C./min;
preferably, the pre-heating in step (3) is carried out for a period of 4-8 h;
preferably, the pre-heating in step (3) is performed in an oxygen atmosphere, and oxygen introduction begins when the temperature increases to 800° C., and ends when the temperature decreases to 800° C., and the oxygen introduction has a flow rate of 20-50 L/min.

10. The preparation method according to claim 4, wherein the mixing in step (4) has a mass ratio of first powder: deionized water: zirconia balls=1: (1-1.3):(4-8);
preferably, the co-solvent in step (4) comprises SiO₂;
preferably, the co-solvent in step (4) has a concentration of 50-500 ppm in the second slurry;
preferably, the ball milling in step (4) has a rotation speed of 50-80 rpm;
preferably, the ball milling in step (4) is carried out for a period of 30-50 h.

11. The preparation method according to claim 4, wherein the binder in step (5) comprises an aqueous solution of polyvinyl alcohol;
preferably, the binder in step (5) has a concentration of 9-11 wt %;
preferably, the binder in step (5) has an addition amount of 8-12 wt %;
preferably, the second powder in step (5) has a particle size X85 of 60-80 μm.

12. The preparation method according to claim 4, wherein the molding in step (6) is performed with a 100T press.

13. The preparation method according to claim 4, wherein a cooling stage of the sintering in step (6) comprises two steps, and specifically, the sintered product is firstly cooled to 600° C. at a rate of 1-2° C./min and then cooled naturally;
preferably, the sintering in step (6) is performed in an oxygen atmosphere, and oxygen introduction begins when the temperature increases to 900° C., and ends when the temperature decreases to 700° C., and the oxygen introduction has a flow rate of 30-50 L/min;
preferably, the grinding in step (6) is performed with a centerless grinder.

14. The preparation method according to claim 4, wherein the preparation method comprises the following steps:
(1) weighing: weighing out corresponding raw materials according to calculation based on the composition of the microwave ferrite material;
(2) primary ball milling: adding the raw materials weighed out in step (1) into a ball milling jar for mixing with a ball mill, feeding materials according to a mass ratio of raw materials: deionized water: zirconia balls=1: (1-1.3):(4-8), adding acetone as a dispersant, and performing ball milling, wherein the ball milling is carried out for a period of 20-40 h with a rotation speed of 60-80 rpm, to obtain a first slurry; the dispersant has a mass proportion of 1-10% in the first slurry, and the first slurry has a particle size X50 of 0.5-1.0 μm;
(3) drying and pre-heating: drying the first slurry obtained in step (2) with an oven, wherein the drying is carried out at a temperature of 120-150° C. for 16-20 h; screening the dried powder with a sieve of 40-80 mesh, and pre-sintering the screened powder with an air sintering furnace, wherein the screened powder is heated to 1200-1300° C. at a rate of 1-2° C./min and held for 4-8 h, to obtain a first powder; the pre-heating is performed in an oxygen atmosphere, and oxygen introduction begins when the temperature increases to 800° C., and ends when the temperature decreases to 800° C., and the oxygen introduction has a flow rate of 20-50 L/min;
(4) secondary ball milling: adding the first powder obtained in step (3) into a ball milling jar for mixing with a ball mill, feeding materials according to a mass ratio of first powder: deionized water: zirconia balls=1: (1-1.3):(4-8), adding SiO₂ as a co-solvent, and performing ball milling, wherein the ball milling is carried out for a period of 30-50 h with a rotation speed of 50-80 rpm, to obtain a second slurry; the co-solvent has a concentration of 50-500 ppm in the second slurry, and the second slurry has a particle size X50 of 0.4-0.9 μm;
(5) granulation: adding an aqueous solution of polyvinyl alcohol as a binder at a concentration of 9-11 wt % to the second slurry obtained in step (4), wherein the binder has an addition amount of 8-12 wt %, and performing centrifugal spray to obtain a second powder which has a particle size X85 of 60-80 μm; and
(6) after-treatment: molding, sintering and grinding the second powder obtained in step (5) sequentially to obtain the microwave ferrite material; the molding is performed with a 100T press and yields a cylinder with a density of 3-3.5 g/cm³; a heating stage of the sintering comprises three steps, specifically, a first sintering, a second sintering and a third sintering which are performed sequentially; the first sintering has a temperature of 550-650° C. and a heating rate of 0.5-1.5° C./min; the second sintering has a temperature of 950-1050° C. and a heating rate of 1.5-2.5° C./min; the third sintering has a temperature of 1400-1500° C., a heating rate of 2-3° C./min, and a holding time of 20-40 h; a cooling stage of the sintering comprises two steps, and specifically, the sintered product is firstly cooled to 600° C. at a rate of 1-2° C./min and then cooled naturally; the sintering is performed in an oxygen atmosphere, and oxygen introduction begins when the temperature increases to 900° C., and ends when the temperature decreases to 700° C., and the oxygen introduction has a flow rate of 30-50 L/min; the grinding is performed with a centerless grinder.

15. (canceled)

16. The preparation method according to claim 4, wherein the first slurry in step (2) has a particle size X50 of 0.5-1.0 μm.

17. The preparation method according to claim 4, wherein the second slurry in step (4) has a particle size X50 of 0.4-0.9 μm.

18. The preparation method according to claim 12, wherein the first sintering has a temperature of 550-650° C.;
preferably, the first sintering has a heating rate of 0.5-1.5° C./min.

19. The preparation method according to claim 12, wherein the second sintering has a temperature of 950-1050° C.;
preferably, the second sintering has a heating rate of 1.5-2.5° C./min.

20. The preparation method according to claim 12, wherein the third sintering has a temperature of 1400-1500° C.;
preferably, the third sintering has a heating rate of 2-3° C./min;
preferably, the third sintering has a holding time of 20-40 h.

21. A method for manufacturing a third-order intermodulation circulator, comprising using the microwave ferrite material according to claim 1.
